(19) United States
(12) Patent Application Publication
(10) Pub. No.: US 2014/0132725 A1
(43) Pub. Date: May 15, 2014

(54) ELECTRONIC DEVICE AND METHOD FOR DETERMINING DEPTH OF 3D OBJECT IMAGE IN A 3D ENVIRONMENT IMAGE

(71) Applicant: INSTITUTE FOR INFORMATION INDUSTRY, Taipei (TW)

(72) Inventors: Wen-Tai HSIEH, Taipei City (TW); Yeh-Kuang WU, New Taipei City (TW)

(21) Appl. No.: 13/906,937

(22) Filed: May 31, 2013

(30) Foreign Application Priority Data
Nov. 13, 2012 (TW) 101142143

(51) Int. Cl. G01C 11/04

(52) U.S. Cl. CPC G01C 11/04
USPC 348/46

(57) ABSTRACT

An electronic device for determining a depth of a 3D object image in a 3D environment image is provided. The electronic device includes a sensor and a processor. The sensor obtains a sensor measuring value. The processor receives the sensor measuring value and obtains a 3D object image with a depth information and a 3D environment image with a depth information, wherein the 3D environment image is separated into a plurality of environment image groups according to the depth information of the 3D environment image and there is a sequence among the plurality of environment image groups, selects one of the environment image groups and determines a corresponding depth of the selected the environment image group as a depth of the 3D object image in the 3D environment image according to the sequence and the sensor measuring value to integrate the 3D object image into the 3D environment image.

### CROSS REFERENCE TO RELATED APPLICATIONS

This application claims priority of Taiwan Patent Application No. 101142143, filed on Nov. 13, 2012, the entirety of which is incorporated by reference herein.

### BACKGROUND OF THE INVENTION

1. Field of the Invention

The present invention relates to an electronic device and method for determining a depth of an object image in an environment image, and in particular relates to an electronic device and method for determining a depth of a 3D object image in a 3D environment image.

2. Description of the Related Art

Currently, many electronic devices, such as smart phones, tablet PCs, portable computers and so on, are configured with a binocular camera/video camera having two lenses (Two-Cameras), a laser stereo camera/video (with a video device using a laser to measure depth values), an infrared stereo camera/video camera (a video device using infrared rays to measure depth values) or a camera/video device supporting stereo vision. For users using the electronic device, it has become more and more popular to obtain 3D depth images by using camera/video devices. However, most manners for controlling the depth of a 3D object image in a 3D environment image in the electronic devices still use control buttons, and the control bar on the screen to adjust the depth of the 3D object image in the 3D environment image. The disadvantage of these manners is that the user has to understand the implications of the control buttons or the control bar first, before the user can adjust the depth by operating the control buttons or the control bar. It is not convenient and not intuitive for the user to use the manner described above to adjust the depth of the 3D object image in the 3D environment image. In addition, the control buttons or the control bar must be displayed on the screen of the electronic device. Because many electronic devices now have miniaturized designs, such as smart phones and tablet computers, the display screens of the electronic devices are quite small. If the control buttons or the control bar described above is on the display screen, the remaining space for display on the display screen will become narrower and may cause inconvenience for the user when viewing the display content on the display screen.

One prior art patent is U.S. Pat. No. 7,007,242 (Graphical user interface for a mobile device). The prior art patent discloses a three-dimensional polyhedron, used to operate a graphical user interface, wherein each of facets of the three-dimensional polyhedron are defined as one of operating movements, such as a rotation, a reversal and other three-dimensional movements. However, the manner still has a problem where the remaining space on the display screen is narrow.

Another prior art patent is U.S. Pat. No. 2007/0265083 (Method and Apparatus for Simulating Interactive Spinning Bar Gymnastics on a 3D Display). The prior art discloses a touch, a rotation button and a stroke bar, being used to control the display of 3D images and rotate 3D objects. However, it is not convenient and not intuitive for the user to use the stroke bar or the 3D rotation button, and the manner still has a problem where the remaining space on the display screen is narrow.

Another prior art patent is U.S. Pat. No. 2011/0093778 (Mobile Terminal and Controlling Method Thereof). The prior art discloses a mobile terminal, being manipulated to display 3D images. The mobile terminal controls icons in different layers by calculating the time interval between touches, or detecting the distance between finger and screen by using a binocular camera and other modules. However, it is not convenient for the user to manipulate the 3D icons precisely by using the time interval between touches and the distance between finger and screen as the input interface, if the user does not learn the operation.

Therefore, there is a need for a method and an electronic device for determining a depth of a 3D object image in a 3D environment image. The method and the electronic device can resolve the problem where the remaining space on the display screen is narrow, and the control buttons or a control bar manner for determining the depth of the 3D object image in the 3D environment image are not needed. It is more convenient for the user to use a sensor of the electronic device for determining the depth of the 3D object image in the 3D environment image and integrate the 3D object image into the 3D environment image.

### BRIEF SUMMARY OF THE INVENTION

A detailed description is given in the following embodiments with reference to the accompanying drawings.

Methods and electronic devices for determining a depth of a 3D object image in a 3D environment image are provided.

In one exemplary embodiment, the disclosure is directed to a method for determining a depth of a 3D object image in a 3D environment image, used in an electronic device, comprising: obtaining a 3D object image with a depth information and a 3D environment image with a depth information from a storage unit; separating, by a clustering module, the 3D environment image into a plurality of environment image groups according to the depth information of the 3D environment image, wherein each of the plurality of environment image groups has a corresponding depth and there is a sequence among the plurality of environment image groups; obtaining, by a sensor, a sensor measuring value; and selecting, by a depth computing module, one of the plurality of environment image groups and determining the corresponding depth of the one of the plurality of environment image groups as a depth of the 3D object image in the 3D environment image according to the sensor measuring value and the sequence of the plurality of environment image groups, wherein the depth of the 3D object image in the 3D environment image is configured to integrate the 3D object image into the 3D environment image.

In one exemplary embodiment, the disclosure is directed to an electronic device for determining a depth of a 3D object image in a 3D environment image, comprising: a sensor, configured to obtain a sensor measuring value; and a processing unit, coupled to the sensor and configured to receive the sensor measuring value and obtain a 3D object image with a depth information and a 3D environment image with a depth information from a storage unit, comprising: a clustering module, configured to separate the 3D environment image into a plurality of environment image groups according to the depth information of the 3D environment image, wherein each of the plurality of environment image groups has a corresponding depth and there is a sequence among the plurality of environment image groups; and a depth computing module, coupled to the clustering module and configured to select one of the plurality of environment image groups and determine the corresponding depth of the one of the plurality of environment image groups as a depth of the 3D object image in the 3D environment image according to the sensor measuring value and the sequence of the plurality of environment image groups, wherein the depth of the 3D object image in the 3D environment image is configured to integrate the 3D object image into the 3D environment image.

In one exemplary embodiment, the disclosure is directed to a mobile device for determining a depth of a 3D object image in a 3D environment image, comprising: a storage unit, configured to store a 3D object image with a depth information and a 3D environment image with a depth information; a sensor, configured to obtain a sensor measuring value; a processing unit, coupled to the storage unit and the sensor, and configured to separate the 3D environment image into a plurality of environment image groups according to the depth information of the 3D environment image, wherein each of the plurality of environment image groups has a corresponding depth and there is a sequence among the plurality of environment image groups, and selects one of the plurality of environment image groups and determines the corresponding depth of the one of the plurality of environment image groups as a depth of the 3D object image in the 3D environment image according to the sensor measuring value and the sequence of the plurality of environment image groups, and integrates the 3D object image into the 3D environment image according to the depth of the 3D object image in the 3D environment image to generate an augmented reality image; and a display unit, coupled to the processing unit and configured to display the augmented reality image.

### BRIEF DESCRIPTION OF THE DRAWINGS

The present invention can be more fully understood by reading the subsequent detailed description and examples with references made to the accompanying drawings, wherein:

FIG. 1 is a block diagram of an electronic device used for determining a depth of a 3D object image in a 3D environment image according to a first embodiment of the present invention.

FIG. 2 is a block diagram of a mobile device used for determining a depth of a 3D object image in a 3D environment image according to a second embodiment of the present invention.

FIG. 3 is a flow diagram illustrating the method for determining a depth of a 3D object image in a 3D environment image according to the first embodiment of the present invention.

FIG. 4 is a flow diagram 400 illustrating the method for determining a depth of a 3D object image in a 3D environment image according to the second embodiment of the present invention.

FIGS. 5A-5B are schematic views illustrating the operation performed by a clustering module according to one embodiment of the present invention.

FIGS. 5C-5D are schematic views illustrating how the clustering module selects the corresponding depth of the plurality of environment image groups according to one embodiment of the present invention.

FIGS. 6A-6C are schematic views illustrating a mobile device 600 configured to display 3D images and determine a sequence of the 3D environment image groups according to another embodiment of the present invention.

FIG. 7 is a block diagram of a mobile device 600 used for determining a depth of a 3D object image in a 3D environment image according to one embodiment of the present invention.

### DETAILED DESCRIPTION OF THE INVENTION

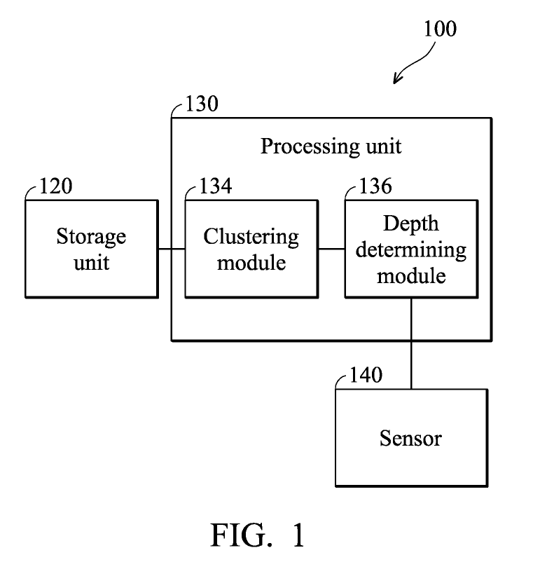

Several exemplary embodiments of the application are described with reference to FIGS. 1 through 7, which generally relate to an electronic device and method for determining a depth of an object image in an environment image. It is to be understood that the following disclosure provides various different embodiments as examples for implementing different features of the application. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

FIG. 1 is a block diagram of an electronic device 100 used for determining a depth of a 3D object image in a 3D environment image according to a first embodiment of the present invention. The electronic device 100 includes a processing unit 130 and a sensor 140, wherein the processing unit 130 further includes a clustering module 134 and a depth computing module 136.

The storage unit 120 is configured to store at least a 3D object image with a depth information and at least a 3D environment image with a depth information. The storage unit 120 and the processing unit 130 can be implemented in the same electronic device (for example, a computer, a notebook, a tablet, a mobile phone, etc.), and can also be implemented in different electronic devices respectively (for example, computers, servers, databases, storage devices, etc.) which are coupled with each other via a communication network, a serial communication (such as RS232) or a bus. The storage unit 120 may be a device or an apparatus which can store information, such as, but not limited to, a hard disk drive, a memory, a Compact Disc (CD), a Digital Video Disk (DVD), a computer or a server and so on.

The sensor 140 can sense a movement applied to the electronic device 100 by a user, and obtains a sensor measuring value, wherein the movement can be a wave, a shake, a tap, a flip, or a swing, etc., and is not limited thereto. The sensor 140 can be an acceleration sensor (an accelerometer), a three-axis gyroscope, an electronic compass, a geomagnetic sensor, a proximity sensor, an orientation sensor, or a sensing element which integrates multiple functions and so on. In other embodiments, the sensor can be used to sense sounds, images or light which affect the electronic device 100. The sensor measurement value obtained by the sensor can be audio, images (such as photos, video streams) and light signals, etc., and the sensor 140 can also be a microphone, a camera, a video camera or a light sensor, and so on.

The processing unit 130 is coupled to the sensor 140 and can receive the sensor measurement value sensed by the sensor 140. The processing unit 130 may include a clustering module 134 and a depth computing module 136.

In the following embodiments, a storage unit 120, inside of the electronic device 100, is coupled to the processing unit 130. In other embodiments, if the storage unit 120 is disposed on the outside of the electronic device 100, the electronic device 100 can also be connected to the storage unit 120 via a communication unit and a communication network (not shown in FIG. 1), and then the storage unit 120 is coupled to the processing unit 130.

The processing unit 130 obtains a 3D object image with a depth information and a 3D environment image with a depth information from the storage unit 120, wherein the clustering module 134 can use an image clustering technique to separate the 3D environment image into a plurality of environment image groups according to the depth information of the 3D environment image and there is a sequence among the plurality of environment image groups. The sequence among the plurality of environment image groups can be determined according to the depth of each of the plurality of environment image groups. For example, in the plurality of environment image groups, the order of the group whose average depth is smaller is in the front of the order of the group whose average depth is larger. In the other embodiments, the order of the group whose average depth is larger is in the front of the order of the group whose average depth is smaller. The sequence among the plurality of environment image groups can also be determined according to an XY-plane position of each of the plurality of environment image groups of in the 3D environment image. For example, the order of the group whose position on the XY-plane is closer to the left side is closer to the front side. The order of the group whose position on the XY-plane is closer to the right side is closer to the back side. In the other embodiments, the order of the group whose position on the XY-plane is closer to the top-side is closer to the front side. The order of the group whose position on the XY-plane is closer to the bottom-side is closer to the back side. In other embodiments, the sequence among the plurality of environment image groups can also be determined according to the space size or the amount of pixels of each of the plurality of environment image groups. It can also be determined by providing an interface to the user for selection. In addition, the sequence among the plurality of environment image groups can also be determined to be random by the clustering module 134. The standard prior art technology can be used in the image clustering technique, such as the K-means algorithm, Fuzzy C-means algorithm, Hierarchical clustering algorithm, Mixture of Gaussians algorithm or other technologies, which will not be described in detail.

In addition to using the depth to separate the groups, the clustering module 134 can also separate the 3D environment image into the plurality of environment image groups according to colors, the similarity of textures or other information of the environmental image.

The depth computing module 136 is coupled to the clustering module 134. According to the sensor measuring value and the sequence among the plurality of environment image groups, the depth computing module 136 selects one of the plurality of environment image groups as a selected environment image group, and determines the corresponding depth of the one of the plurality of environment image groups as a depth of the 3D object image in the 3D environment image. The depth of the 3D object image in the 3D environment image can be used for integrating the 3D object image into the 3D environment image.

In other embodiments, the processing unit 130 further comprises an augmented reality module which is coupled to the depth computing module 136. The augmented reality module is configured to integrate the 3D object image into the 3D environment image to generate an augmented reality image according to the depth of the 3D object image in the 3D environment image. For example, when the 3D object image is integrated into the 3D environment image, the augmented reality module integrates the 3D object image into the 3D environment image, and then adjusts an XY-plane display scale of the 3D object image according to an original depth of the 3D object image and the depth of the 3D object image in the 3D environment image. The original depth of the 3D object image is generated according to the depth information of the 3D object image. For example, a geometric center, a barycenter of the 3D object image, a point with the minimum depth value in the 3D object image, or any one of the specified points can be selected as a basis point. Then, a depth of the basis point is used as the original depth.

In the other embodiments, on the XY-plane, a point situated at the bottom of the Y-axis orientation and in the middle of the Z-axis orientation of the XY-plane position of the 3D object image can be specified as a basis point. Then, a depth of the basis point obtained from the depth information is used as the original depth of the 3D object image, and the corresponding depth of the one of the plurality of environment image groups (such as the selected environment image group described above) is used as the depth of the basis point in the 3D environment image. Finally, the XY-plane display scale of the 3D object image in the augmented reality image is adjusted according to the depth of the basis point in the 3D environment image and the original depth of the 3D object image. For example, the object is closer to the human eye, the visual angle of the human is larger. It means that, a length and an area of the object observed by the human eye will be larger. The object is further away from the human eye, the visual angle of the human is smaller. Then, the length and the area of the object observed by the human eye will be smaller. When the original depth of the 3D object image is 100 centimeters (namely, the depth of the basis point in the 3D object image is 100 centimeters), the display size of the 3D object images on the XY-plane is 20 centimeters×30 centimeters. When the depth computing module 136 determines that the depth of the 3D object image in the 3D environment image is 200 centimeters, the X axial length, the Y axial length, and the XY-plane display size of the object image in the 3D environment image are reduced according to the percentage of 100 divided by 200. That is to say, the display size of the 3D object image on the XY-plane is reduced to 10 centimeters×15 centimeters.

In some embodiments, the storage unit 120 can store a sensor measuring threshold in advance. The step of selecting one of the plurality of environment image groups by the depth computing module 136 can be implemented by selecting one of the environment image groups according to the sequence when the sensor measuring value is greater than the sensor measuring threshold. For example, if there is none of the environmental image groups been selected by the depth computing module 136, the depth computing module 136 can determine an environment image group in the first order as the selected environment image group. When one of the plurality of environmental image groups is selected, the depth computing module 136 can also determine another environment image group whose order is after the selected one of the plurality of environment image groups as the updated environment image group according to the sequence and the selected environment image group. That is to say, when no plurality of environment image groups are selected and the sensor measuring value is greater than the sensor measuring threshold, the depth computing module 136 changes the one of the plurality of environment image groups according to the sequence. When the plurality of environment image groups are selected and the sensor measuring value is greater than the sensor measuring threshold, the depth computing module 136 changes the selected plurality of environment image groups according to the sequence. For example, the depth computing module 136 determines another environment image group whose order is following the selected one of the plurality of environment image groups as the updated selected environment image group.

In other embodiments, the augmented reality module can obtain an upper bound of a fine-tuning threshold and a lower bound of the fine-tuning threshold from the storage unit 120. When the augmented reality module further determines that the sensor measuring value is between the upper bound of the fine-tuning threshold and the lower bound of the fine-tuning threshold, the augmented reality module fine tunes and updates the depth of the 3D object image in the 3D environment image. In a particular embodiment, the upper bound of the fine-tuning threshold is set to equal to or smaller than a specific sensor measuring value, and the lower bound of the fine-tuning threshold is set to be smaller than the upper bound of the fine-tuning threshold. In this embodiment, when the sensor measuring value is greater than the sensor measuring threshold, the depth computing module 136 selects or changes the selected environmental group to adjust the depth of the 3D object image in the 3D environment image greatly. When the sensor measuring value is smaller than the sensor measuring threshold and between the upper bound of the fine-tuning threshold and the lower bound of the fine-tuning threshold, the depth computing module 136 increases or decreases the depth slightly instead of selecting and changing the selected environmental group according to the current depth of the 3D object image in the 3D environment image. For example, the depth computing module 136 increases or decreases a certain value (5 centimeters) to the current depth of the 3D object image in the 3D environment image each time, or increases or decreases the corresponding depth according to the difference between the sensor measuring value and the upper bound of a fine-tuning threshold. In other embodiments, the processing unit 130 may further include an initiation module. The initiation module provides an initial function to start performing the step of determining the depth of the 3D object image in the 3D environment image. For example, the initiation module can be a boot interface generated by an application, wherein the initiation module starts to perform the related functions described in the first embodiment after the user operates the initiation module or when the initiation module determines that the sensor measuring value sensed by the sensor 140 at the first time is greater than the sensor measuring threshold, the initiation module starts to perform the related functions described in the first embodiment. Alternatively, when the initiation module determines that the corresponding sensor measuring value sensed by another sensor which is different from the sensor 140 (not shown in FIG. 1) is greater than a predetermined initiation threshold, the initiation module starts to perform the related functions described in the first embodiment.

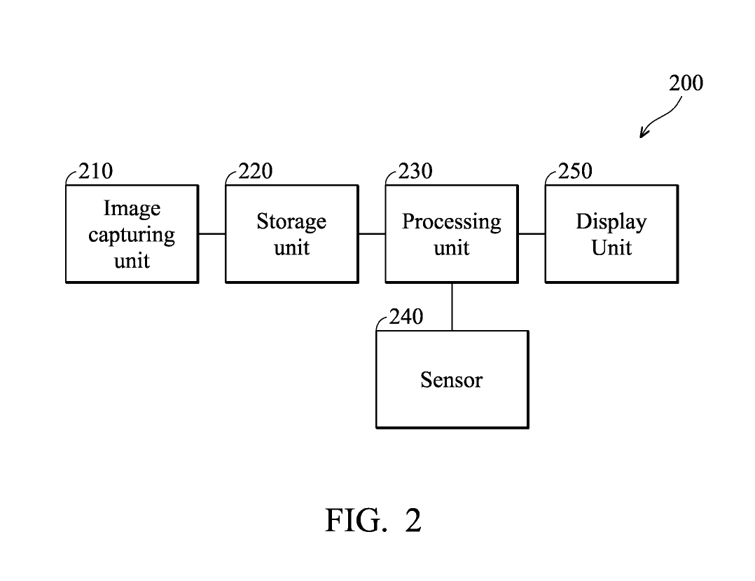

FIG. 2 is a block diagram of a mobile device 200 used for determining a depth of a 3D object image in a 3D environment image according to a second embodiment of the present invention. The mobile device 200 includes a storage unit 220, a processing unit 230, a sensor 240 and a display unit 250. In other embodiments, the mobile device 200 may further include an image capturing unit 210.

The storage unit 220 is configured to store at least a 3D object image with a depth information and at least a 3D environment image with a depth information. The sensor 240 is configured to obtain a sensor measuring value. The storage unit 120, the sensor 240 and other related technologies are the same as the illustration of the first embodiment described above, so the details related to the technologies of the system will be omitted. The processing unit 230 is coupled to the storage unit 220 and the sensor 240. The processing unit 230 separates the 3D environment image into a plurality of environment image groups according to the depth information of the 3D environment image, wherein each of the plurality of environment image groups has a corresponding depth and there is a sequence among the plurality of environment image groups. The processing unit 230 selects one of the plurality of environment image groups and determines the corresponding depth of the one of the plurality of environment image groups as a depth of the 3D object image in the 3D environment image according to the sensor measuring value and the sequence of the plurality of environment image groups. Then, the processing unit 230 integrates the 3D object image into the 3D environment image to generate an augmented reality image according to the depth of the 3D object image in the 3D environment image. The display unit 250 is coupled to the processing unit 230 and is configured to display the augmented reality image. The image capturing unit 210 is coupled to the storage unit 220 and is used to capture a 3D object image and a 3D environment image from an object and an environment respectively, wherein the 3D object image and the 3D environment image are the 3D images with the depth values, and the 3D object image and the 3D environment image captured (or photographed) by the image capturing unit 210 can be stored in the storage unit 220. The image capturing unit 210 may be a device or an apparatus which can capture 3D images. For example, a binocular camera/video camera having two lenses, a camera/video camera which can photograph two sequential photos, a laser stereo camera/video camera (a video device using laser to measure depth values), an infrared stereo camera/video camera (a video device using infrared rays to measure depth values), etc.

The processing unit 230 is coupled to the storage unit 220 and calculates a depth information of the 3D object image and a 3D environment image depth of the 3D environment image, respectively, by using dissimilarity analysis and stereo vision analysis. Furthermore, the processing unit 230 can perform a function for taking out a 3D object image, and clustering the 3D object image to distinguish a plurality of 3D object image groups. Then, a 3D object image group is taken out from the plurality of 3D object image groups as the updated 3D object image.

In the second embodiment, the processing unit 230 integrates the updated 3D object image into the 3D environment image according to the depth of the 3D object image in the 3D environment image to generate an augmented reality image. In the augmented reality image, an XY-plane display scale of the 3D object image is generated according to an original depth of the 3D object image and the depth of the 3D object image in the 3D environment image.

The display unit 250 is coupled to the processing unit 230 and is configured to display the 3D environment image. The display unit 250 further uses specific lines, frame lines, particular colors or image changes to display the one of the plurality of environment image groups among the plurality of environment image groups so that the user can recognize the current and selected environment image group clearly. In addition, the display unit 250 can also be configured to display the 3D object image, a plurality of 3D object image groups, the 3D object image group which is taken out from the plurality of 3D object image groups and the augmented reality image. The display unit 250 may be a display, such as a cathode ray tube (CRT) display, a touch-sensitive display, a plasma display, a light emitting diode (LED) display, and so on.

In the second embodiment, the mobile device further includes an initiation module (not shown in FIG. 2). The initiation module is configured to start to determine the depth of the 3D object image in the 3D environment image.

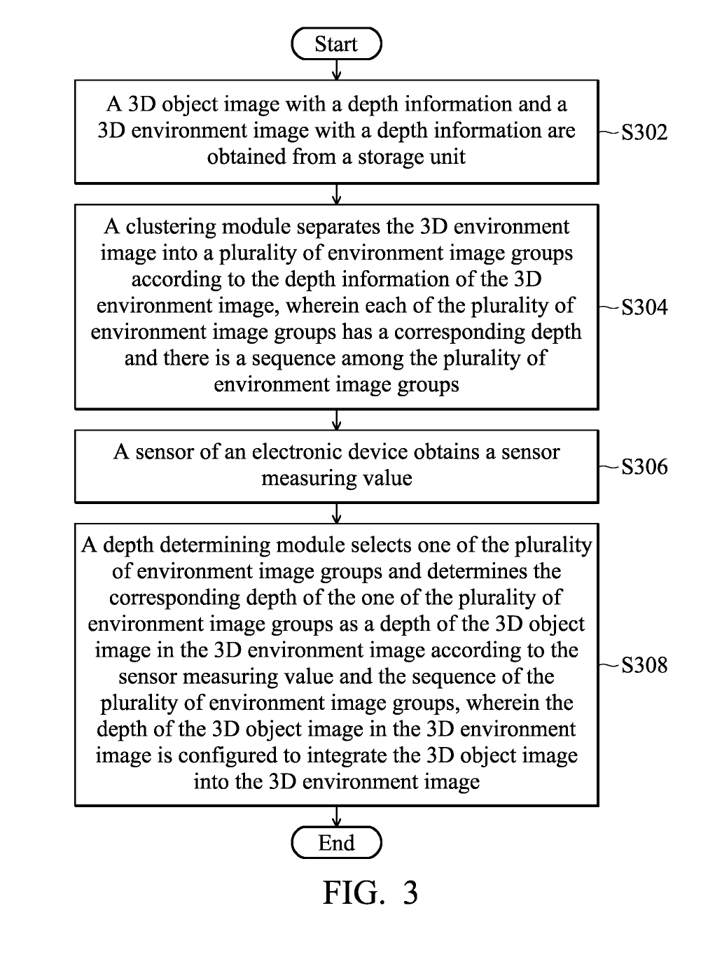

FIG. 3 is a flow diagram 300 illustrating the method for determining a depth of a 3D object image in a 3D environment image according to the first embodiment of the present invention with reference to FIG. 1. First, in step S302, a 3D object image with a depth information and a 3D environment image with a depth information are obtained from a storage unit. In step S304, a clustering module separates the 3D environment image into a plurality of environment image groups according to the depth information of the 3D environment image, wherein each of the plurality of environment image groups has a corresponding depth and there is a sequence among the plurality of environment image groups. In step S306, a sensor of an electronic device obtains a sensor measuring value. Finally, in step S308, a depth computing module selects one of the plurality of environment image groups and determines the corresponding depth of the one of the plurality of environment image groups as a depth of the 3D object image in the 3D environment image according to the sensor measuring value and the sequence of the plurality of environment image groups, wherein the depth of the 3D object image in the 3D environment image is configured to integrate the 3D object image into the 3D environment image.

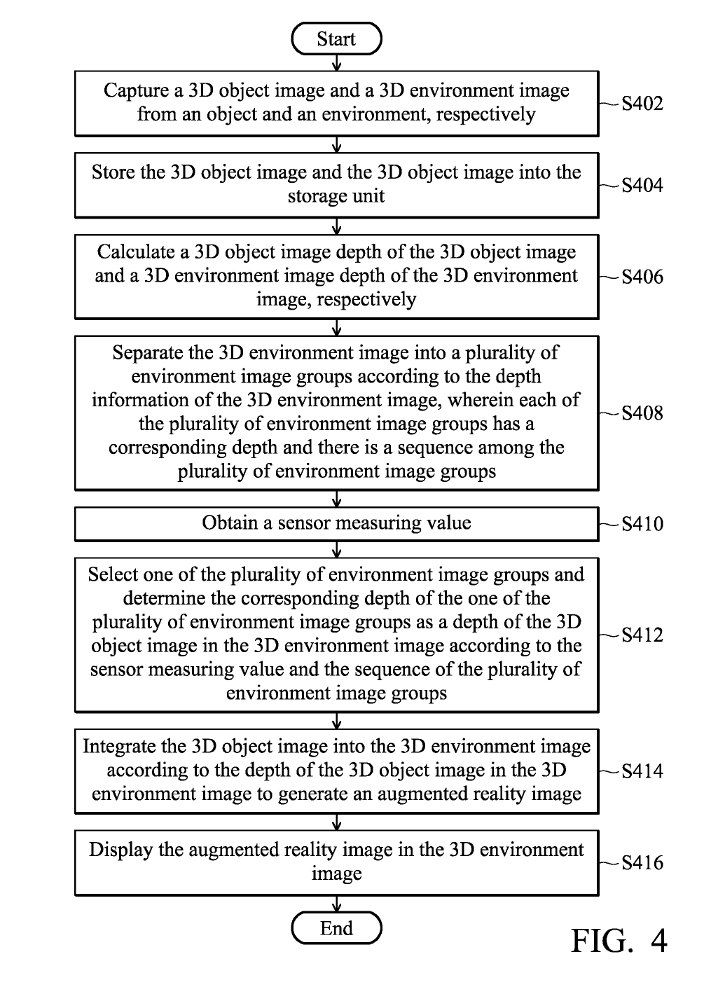

FIG. 4 is a flow diagram 400 illustrating the method for determining a depth of a 3D object image in a 3D environment image according to the second embodiment of the present invention with reference to FIG. 2. First, in step S402, an image capturing unit captures a 3D object image and a 3D environment image from an object and an environment, respectively. Next, in step S404, after the image capturing unit captures the images, the image capturing unit stores the 3D object image and the 3D object image into the storage unit. In step S406, a processing unit calculates a depth information of the 3D object image and a 3D environment image depth of the 3D environment image, respectively. Then, in step S408, the processing unit separates the 3D environment image into a plurality of environment image groups according to the depth information of the 3D environment image, wherein each of the plurality of environment image groups has a corresponding depth and there is a sequence among the plurality of environment image groups. In step S410, a sensor obtains a sensor measuring value. In step S412, the processing unit selects one of the plurality of environment image groups and determines the corresponding depth of the one of the plurality of environment image groups as a depth of the 3D object image in the 3D environment image according to the sensor measuring value and the sequence of the plurality of environment image groups. In step S414, the processing unit integrates the 3D object image into the 3D environment image according to the depth of the 3D object image in the 3D environment image to generate an augmented reality image. Finally, a display unit displays the augmented reality image in the 3D environment image.

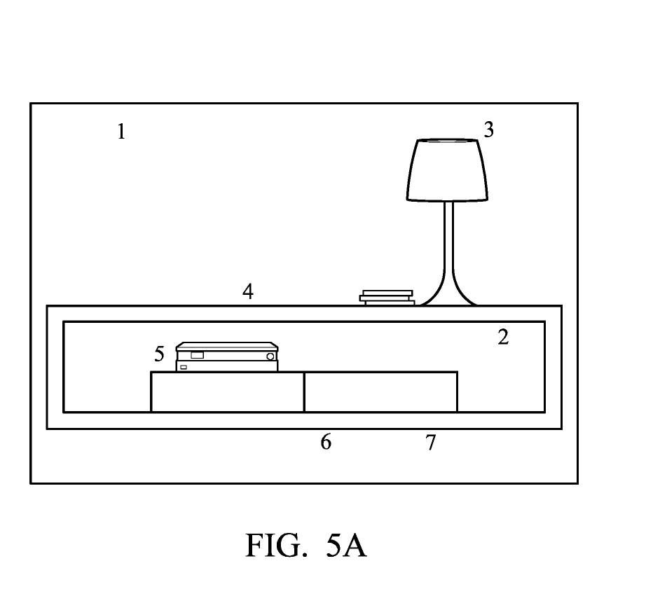

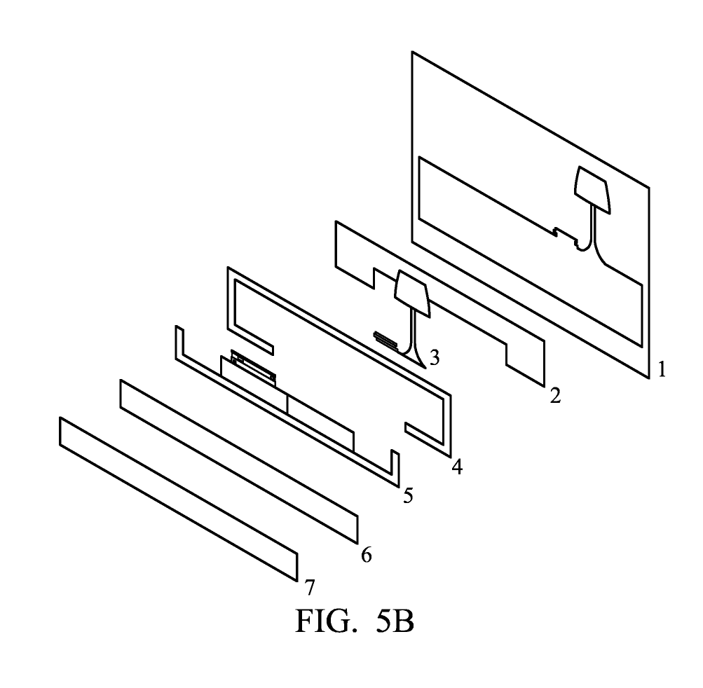

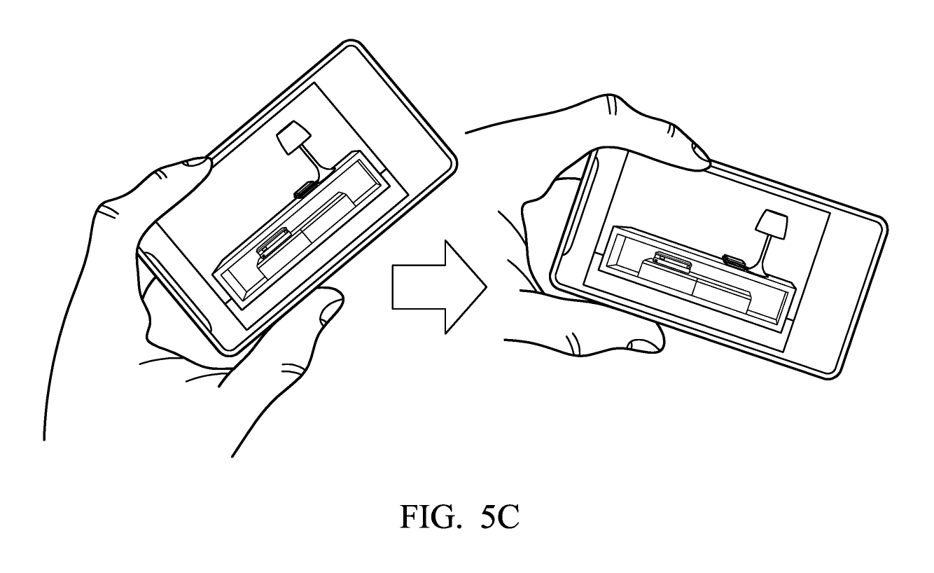

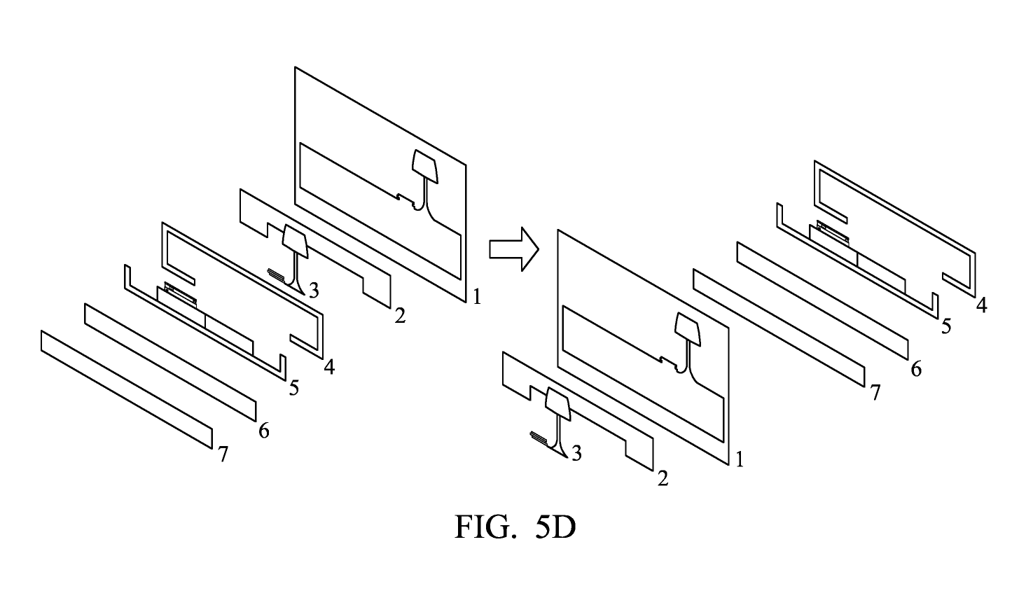

FIGS. 5A-5B are schematic views illustrating the operation performed by a clustering module according to one embodiment of the present invention. As shown in FIGS. 5A-5B, in the 3D environment images, each of the plurality of environment image groups has a corresponding depth, and there is a sequence among the plurality of environment image groups. The 3D environment image can be separated into 7 groups according to the sequence of the depth values from deep to shallow in FIGS. 5A-5B. FIGS. 5C-5D are schematic views illustrating how the clustering module selects the corresponding depth of the plurality of environment image groups. As shown in FIG. 5C, a user waves an electronic device. The depth computing module determines an environment image group in the first order as the one of the plurality of environment image groups according to the sequence when the sensor measuring value is greater than the sensor measuring threshold. As shown in FIG. 5D, the depth computing module determines that the group 3 in the first order as the selected environmental image groups.

In some embodiments, when a user taps the electronic device (i.e. the user taps the electronic device) and the augmented reality module determines that the sensor measuring value is between the upper bound and the lower bound of the fine-tuning threshold, the augmented reality module fine-tunes the depth of the 3D object images in the augmented reality image.

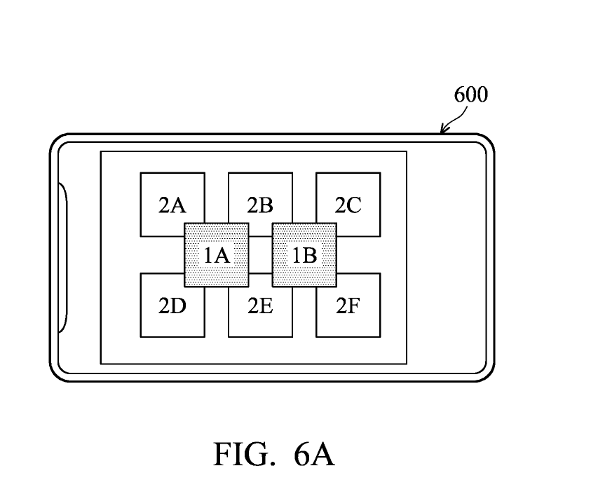

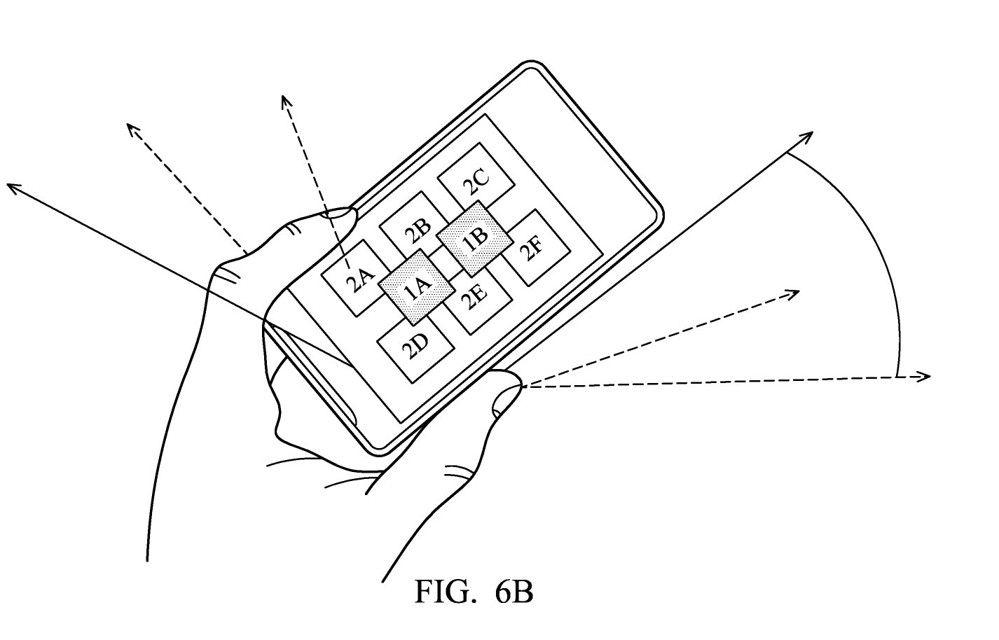

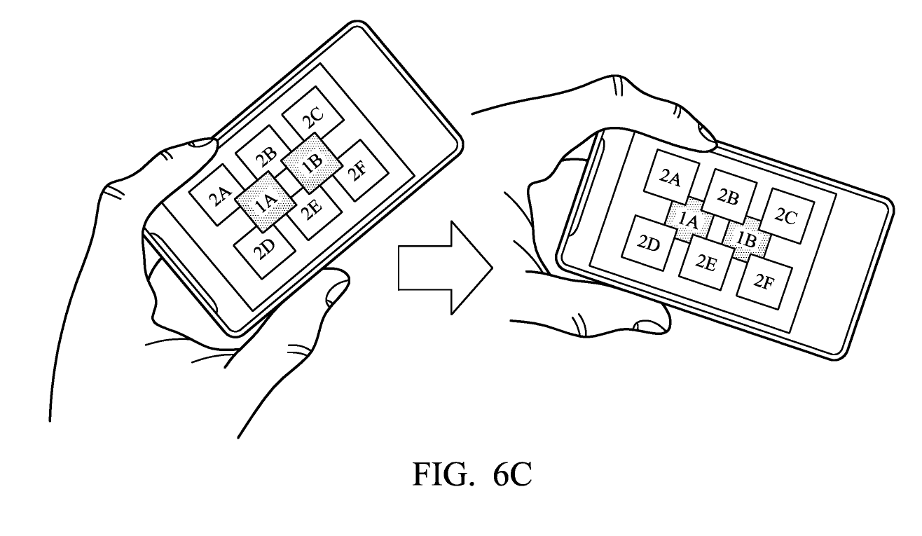

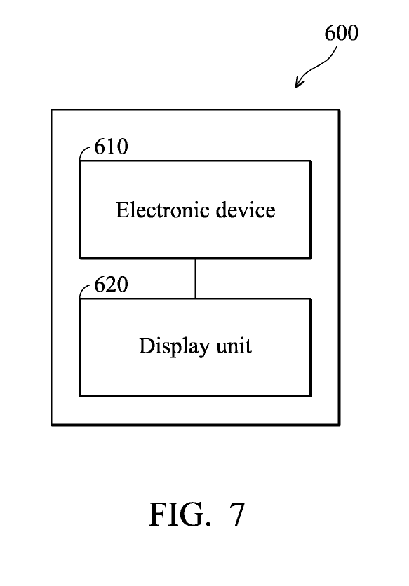

FIGS. 6A-6C are schematic views illustrating a mobile device 600 configured to display 3D images and determine a sequence of the 3D environment image groups according to another embodiment of the present invention. The mobile device 600 may include an electronic device 610 which determines that the depth of the 3D object image in a 3D environment and a display unit 620, as shown in FIG. 7. The electronic device 610 is the same as the control device 100 in the first embodiment, and the functions of the electronic device 610 are the same as the illustration of the first embodiment described above, so the details related to the functions of the electronic device 610 will be omitted.

As shown in FIG. 6A, the mobile device 600 can display icons of different depth layers. The icon 1A and the icon 1B belong to the same depth layer, and the icons 2A˜2F belong to another level and are located behind the icon 1A and the icon 1B. As shown in FIG. 6B, the user waves the mobile device 600. The sensor senses the wave, and obtains a sensor measuring value. As shown in FIG. 6C, the depth computing module determines that when the sensor measuring value is greater than the sensor measuring threshold, the icons 2A˜2F whose orders are following the icon 1A and icon 1B, is the updated and selected environment image group.

Therefore, there is no need for the user to use control buttons or a control bar by using the method and the electronic device for determining a depth of a 3D object image in a 3D environment image according to the invention. The method and the electronic device according to the invention can determine the depth of the 3D object image in the 3D environment image, and integrate the 3D object image into the 3D environment image.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for determining a depth of a 3D object image in a 3D environment image, used in an electronic device, the method comprising:
obtaining a 3D object image with a depth information and a 3D environment image with a depth information from a storage unit;
separating, by a clustering module, the 3D environment image into a plurality of environment image groups according to the depth information of the 3D environment image, wherein each of the plurality of environment image groups has a corresponding depth and there is a sequence among the plurality of environment image groups;
obtaining, by a sensor, a sensor measuring value; and
selecting, by a depth computing module, one of the plurality of environment image groups and determining the corresponding depth of the one of the plurality of environment image groups as a depth of the 3D object image in the 3D environment image according to the sensor measuring value and the sequence of the plurality of environment image groups, wherein the depth of the 3D object image in the 3D environment image is configured to integrate the 3D object image into the 3D environment image.

2. The method for determining a depth of a 3D object image in a 3D environment image as claimed in claim 1, wherein the sensor measuring value is obtained by the sensor according to a movement, wherein the movement is one of a wave, a shake and a tap.

3. The method for determining a depth of a 3D object image in a 3D environment image as claimed in claim 1, further comprising:
obtaining a sensor measuring threshold from the storage unit,
wherein the step of selecting one of the plurality of environment image groups is that determining a environment image group in the first order as the one of the plurality of environment image groups according to the sequence, or determining another environment image group whose order is following the one of the plurality of environment image groups as the updated and selected environment image group according to the sequence and the one of the plurality of environment image groups, when the sensor measuring value is greater than the sensor measuring threshold.

4. The method for determining a depth of a 3D object image in a 3D environment image as claimed in claim 1, further comprising:
integrating, by an augmented reality module, the 3D object image into the 3D environment image according to the depth of the 3D object image in the 3D environment image and generating an augmented reality image,
wherein, in the augmented reality image, an XY-plane display scale of the 3D object image is adjusted according to an original depth of the 3D object image and the depth of the 3D object image in the 3D environment image, wherein the original depth of the 3D object image is generated according to the depth information.

5. The method for determining a depth of a 3D object image in a 3D environment image as claimed in claim 4, wherein the step of integrating the 3D object image into the 3D environment image is that determining a point situated at the bottom of the Y-axis orientation and in the middle of the Z-axis orientation of the XY-plane position of the 3D object image as a basis point, determining the corresponding depth of the one of the plurality of environment image groups as a depth of the basis point, determining a depth information of the basis point as the original depth according to the depth information, and adjusting the XY-plane display scale of the 3D object image in the augmented reality image according to the original depth.

6. The method for determining a depth of a 3D object image in a 3D environment image as claimed in claim 1, wherein the corresponding depth of each of the plurality of environment image groups is a depth of a geometric center, a depth of a barycenter or a depth with the minimum depth value in each of the plurality of environment image groups.

7. The method for determining a depth of a 3D object image in a 3D environment image as claimed in claim 1, further comprising:
obtaining an upper bound of a fine-tuning threshold and a lower bound of the fine-tuning threshold from the storage unit; and
fine-tuning, by the augmented reality module, and updating the depth of the 3D object image in the 3D environment image when determining that the sensor measuring value is between the upper bound of the fine-tuning threshold and the lower bound of the fine-tuning threshold.

8. The method for determining a depth of a 3D object image in a 3D environment image as claimed in claim 1, further comprising:
displaying, by a display unit, the 3D environment image and using specific lines, frame lines, particular colors or image changes to display the one of the plurality of environment image groups among the plurality of environment image groups.

9. The method for determining a depth of a 3D object image in a 3D environment image as claimed in claim 1, further comprising:
providing, by an initiation module, an initial function to start performing the step of determining the depth of the 3D object image in the 3D environment image.

10. An electronic device for determining a depth of a 3D object image in a 3D environment image, comprising
a sensor, configured to obtain a sensor measuring value; and
a processing unit, coupled to the sensor and configured to receive the sensor measuring value and obtain a 3D object image with a depth information and a 3D environment image with a depth information from a storage unit, comprising:
a clustering module, configured to separate the 3D environment image into a plurality of environment image groups according to the depth information of the 3D environment image, wherein each of the plurality of environment image groups has a corresponding depth and there is a sequence among the plurality of environment image groups; and
a depth computing module, coupled to the clustering module and configured to select one of the plurality of environment image groups and determine the corresponding depth of the one of the plurality of environment image groups as a depth of the 3D object image in the 3D environment image according to the sensor measuring value and the sequence of the plurality of environment image groups, wherein the depth of the 3D object image in the 3D environment image is configured to integrate the 3D object image into the 3D environment image.

11. The electronic device for determining a depth of a 3D object image in a 3D environment image as claimed in claim 10, wherein the sensor senses a movement to obtain the sensor measuring value, and the movement is one of a wave, a shake and a tap.

12. The electronic device for determining a depth of a 3D object image in a 3D environment image as claimed in claim 10, wherein when the depth computing module selects one of the plurality of environment image groups as the selected environment image group, the depth computing module obtains a sensor measuring threshold from the storage unit and determines a environment image group in the first order as the one of the plurality of environment image groups according to the sequence, or determines another environment image group whose order is following the one of the plurality of environment image groups as the updated and selected environment image group, when the sensor measuring value is greater than the sensor measuring threshold.

13. The electronic device for determining a depth of a 3D object image in a 3D environment image as claimed in claim 10, wherein the processing unit further comprises:
an augmented reality module, coupled to the depth computing module and configured to integrate the 3D object image into the 3D environment image to generate an augmented reality image according to the depth of the 3D object image in the 3D environment image,
wherein in the augmented reality image, an XY-plane display scale of the 3D object image is adjusted according to an original depth of the 3D object image and the depth of the 3D object image in the 3D environment image, wherein the original depth of the 3D object image is generated according to the depth information.

14. The electronic device for determining a depth of a 3D object image in a 3D environment image as claimed in claim 13, wherein the augmented reality module determines a point situated at the bottom of the Y-axis orientation and in the middle of the Z-axis orientation of the XY-plane position of the 3D object image as a basis point, determines the corresponding depth of the one of the plurality of environment image groups as a depth of the basis point, determines a depth information of the basis point as the original depth according to the depth information, and adjusts the XY-plane display scale of the 3D object image in the augmented reality image according to the original depth.

15. The electronic device for determining a depth of a 3D object image in a 3D environment image as claimed in claim 14, wherein the corresponding depth of each of the plurality of environment image groups is a depth of a geometric center, a depth of a barycenter or a depth with the minimum depth value in each of the plurality of environment image groups.

16. The electronic device for determining a depth of a 3D object image in a 3D environment image as claimed in claim 10, wherein the augmented reality module obtains an upper bound of a fine-tuning threshold and a lower bound of the fine-timing threshold, and the augmented reality module further fine times and updates the depth of the 3D object image in the 3D environment image when the augmented reality module determines that the sensor measuring value is between the upper bound of the fine-tuning threshold and the lower bound of the fine-tuning threshold.

17. The electronic device for determining a depth of a 3D object image in a 3D environment image as claimed in claim 10, further comprising:
a display unit, configured to display the 3D environment image, and uses specific lines, frame lines, particular colors or image changes to display the one of the plurality of environment image groups among the plurality of environment image groups.

18. The electronic device for determining a depth of a 3D object image in a 3D environment image as claimed in claim 10, wherein the processing unit further comprises:
an initiation module, configured to provide an initial function to start to determine the depth of the 3D object image in the 3D environment image.

19. A mobile device for determining a depth of a 3D object image in a 3D environment image, comprising
a storage unit, configured to store a 3D object image with a depth information and a 3D environment image with a depth information;
a sensor, configured to obtain a sensor measuring value;
a processing unit, coupled to the storage unit and the sensor, and configured to separate the 3D environment image into a plurality of environment image groups according to the depth information of the 3D environment image, wherein each of the plurality of environment image groups has a corresponding depth and there is a sequence among the plurality of environment image groups?, and select one of the plurality of environment image groups and determine the corresponding depth of the one of the plurality of environment image groups as a depth of the 3D object image in the 3D environment image according to the sensor measuring value and the sequence of the plurality of environment image groups, and integrate the 3D object image into the 3D environment image according to the depth of the 3D object image in the 3D environment image to generate an augmented reality image; and
a display unit, coupled to the processing unit and configured to display the augmented reality image.
